(19) United States
(12) Patent Application Publication
(10) Pub. No.: US 2004/0117797 A1
(43) Pub. Date: Jun. 17, 2004

(54) Interactive dialer

(76) Inventors: Johnny Michael Brown, Cedar Rapids, IA (US); Pong Cavan, Coralville, IA (US); Yua Cavan, Coralville, IA (US)

Correspondence Address: Johnny M. Brown, 5309 Oak Creek Dr. NE, Cedar Rapids, IA, 52411, US

(21) Appl. No.: 10/223,098

(22) Filed: Dec. 16, 2002

(51) Int. Cl. H04N 7/173

(52) U.S. Cl. 719/310

(57) ABSTRACT

An Interactive Dialer© with built-in ISP Client-specific authentication features is disclosed which provides graphic or written messages on an interactive menu via push technology, while the user is simultaneously accessing an Internet dial-up connection. An administration site for the Internet Service Provider Client (ISP Client) to manage these messages is provided.

### BACKGROUND OF THE INVENTION

The invention shortens the time it would typically take to make a user aware of an a) message topic; b) new mail received; c) other media data.

When a user accesses the Internet in a typical dial-up mode setting, an Internet dial-up menu will appear on the computer screen, waiting for user input to activate the connection. While the user credentials are being verified, there is a time delay until access is granted. The ISP can now use this time to activate the sending of important data/interactive call forms via the Interactive Dialer© for visual display to the user, while he is waiting for access. Existing dial-up menus are non-informative/interactive after starting the connection process.

### SUMMARY OF THE INVENTION

This invention relates to the way by which users access the Internet, in particular via dial-up or analog/digital phone line access.

The dialog menu, which appears on a computer user's monitor screen, is given new innovative functionality. In addition to prompting the request for logon credentials, this menu can provide a) a field with a changeable display of data from the ISP Client to the user or a selected user group for reading and viewing; b) a notification to the individual that he has new email; c) a hyperlink to a URL on the Internet or other information. As the authentication of credentials is in progress, a program on the ISP Client's host server activates as the user is recognized and automatically sends a) data to the user's Interactive Dialer© display and b) checks if this user account has received new emails since the account was last accessed; c) updates any other information in the display body of the Interactive Dialer©. The invention shortens the time it would typically take to make a user aware of the a) message topic; b) new mail received; c) other media data.

One object of the invention is to apply a variety of tools to draw a user's attention to an important message BEFORE he actually has browsing access to the Internet—“the step before www”.

Another object of the invention is to let a user know whether he has NEW email BEFORE he purposely goes through the steps required to access and open his Internet email.

Another object of the invention is to allow the user to go directly to see more detail about a data display by activating a hyperlink embedded in the Interactive Dialer©.

Another object of the invention is to allow the user to go directly to his email inbox by activating a hyperlink embedded in the Interactive Dialer©.

Another object of the invention is to push data and facilitate pulling of more data via the Interactive Dialer© as a communication platform for an ISP Client, giving the ISP Client the capability to reach his user before he has browsing access to the Internet.

Another object of the invention is to provide each ISP Client with a specific Interactive Dialer©, allowing for name-branding, while at the same time preventing other dialer designs from accessing the user account, by way of security features built directly into the Interactive Dialer©.

The code in which this program is written is interoperable/compatible with all commonly existing computer operating systems, such as Microsoft Windows, Apple PC, Linux, Unix, Sun. This code is maintained and serviced on the server network of an Internet Access Provider. An executable file for the Interactive Dialer© resides on the Internet user's computer to be activated on demand.

### DESCRIPTION OF THE DRAWING FIGURES

The drawing in FIG. 1 depicts a generic graphical appearance of the menu tool commonly used to access the Internet.

FIG. 2 is a flowchart that depicts the special functionality of the OnDial and Push Processes of the invention FIG. 3 is a flowchart that shows the primary flow of the Interactive Dialer© per se and within the supra-structure in which this invention operates.

### DETAILED DESCRIPTION OF THE INVENTION

Referring to the drawing, FIG. 1 depicts the central object of the invention, the Interactive Dialer©, and the basic elements of the 1 supra-structure in which the invention operates. It is a custom-designed client file/executable for Internet Service Provider Clients and is designed to provide Internet access and additional features. Any portion of the graphics display is customizable for interactive functionality via push technology, and thus is the subject of this invention.

The look and feel of the Interactive Dialer© follows traditional dialer designs, with a region containing dialog fields for the user's information, local dial-up access numbers, connection status field, and settings preferences.

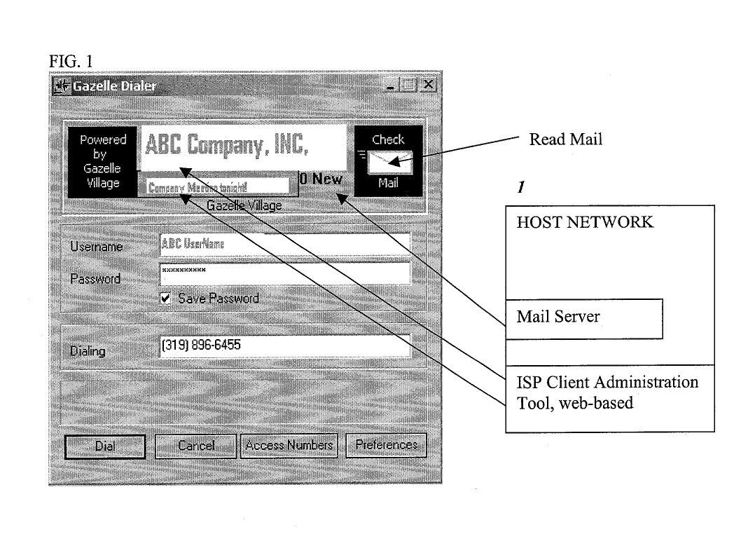

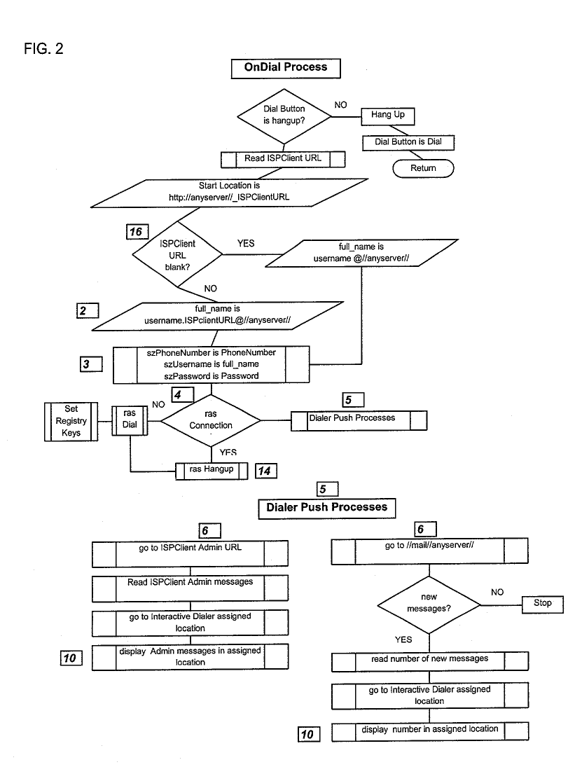

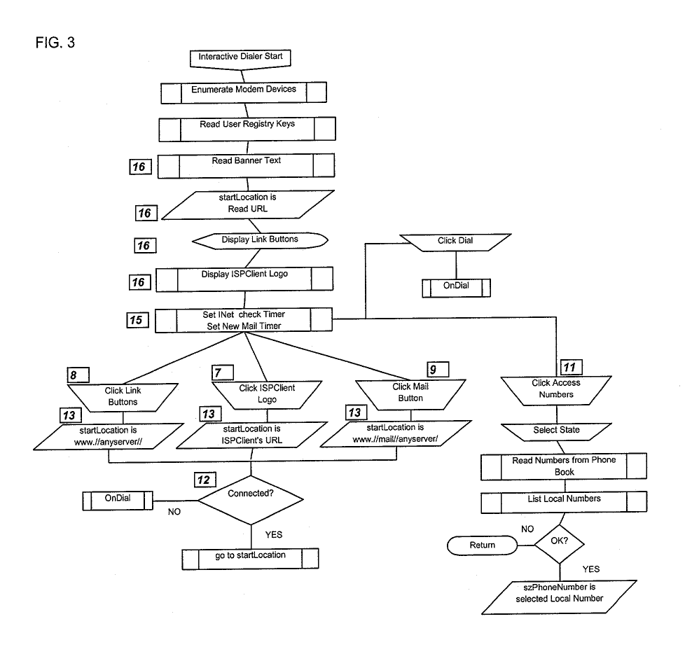

FIG. 2 depicts the OnDial Process and how the additional interactive features interoperate during the connection process to the Internet.

a. 5 Information is pushed from ISP to user

b. 6, 10 Intuitive design for how the pushed information is updated

c. 2 User information and Interactive Dialer© authentication is provided by any remote access server (RAS) system (e.g. Microsoft RAS API).

d. 3 The Phone Number field contains the dialup phone number that will be used by the remote access server system to dial. This value is saved on the user's computer for the next dialup attempt.

e. 4 The RAS Response Region is provided to inform the user of the status of their dialup attempt. All stages of the dialup process are displayed.

f. The Command Region contains the main program buttons. These buttons provide functionality for the Interactive Dialer© (i.e. FIGS. 3. 7, 8, 9, 11)

FIG. 3 depicts the processes unique to this invention during the activation stages of the Interactive Dialer©. The invention relates to other regions incorporated into the Interactive Dialer© that are designed to contain interactive components. These interactive components consist of, but are not limited to:

a. 7 An ISP Client's logo or other branding

b. 8 Any number of hyperlinks to worldwide websites

c. 9 An email link and notification

d. 10 Push-message display area

e. 11 Dial-up local Access Numbers are stored in a CSV file

f. 12 The Interactive Dialer utilizes RAS logic to create a connection to the Internet

g. 13 The default URL can be changed “mid-stream”.

h. 14 Upon connection, the Interactive Dialer© will indicate Hangup and Show Status

i. 15 New Mail status is displayed immediately on the face of the Dialer

j. 16 The Interactive Dialer© places the logo, changeable message text, and company URLs in the Banner/Logo section.

The Interactive Dialer© and Companion Page© (see below) are capable of containing all forms of communication media, such as:

a. Hyperlinks

b. All email versions and protocols

c. All video and animations protocols

d. All graphics protocols

e. All Web/televideo-casting protocols

f. All voice over IP protocols

g. All Internet protocols

### Operation of the Invention

There are different operator levels intended to operate this invention, separated by security features. The operator levels indicated herein are illustrative only, rather than restrictive to this invention.

Operator is the end user who wants to access the Internet. This operator uses the Interactive Dialer© to

a. Access the Internet the same way Internet Dialing menus are commonly used, by clicking the “Dial” button command, and going directly to the ISP Client's “Companion Page©”

b. Access the Internet using one of the embedded URL-links on the face of the Interactive Dialer©, and going directly to the linked website.

c. Access Internet email by clicking the email link on the face of the Interactive Dialer©, and going directly to the email login.

Operator is the ISP Client's administrator who has security clearance to a “Companion Administration Template©”. This page has several fields in which the administrator can edit information, which will be displayed

a. In the push-message region(s) of the Interactive Dialer or

b. In the Interactive Dialer©'s default URL or sub-domain, which is the ISP Client's “Companion Page©”

Operator is the host network's Internet Access Provider.

a. This operator creates and maintains the ISP Client's sub-domain containing the “Companion Page©” and “Companion Administration Template©”.

b. This operator also creates the authentication requirements to allow access to the network via the Interactive Dialer©

Having described the invention, we claim:

1. Programming Design and Logic to enable the invention as said,
an interactive Internet dial-up menu,
said to provide the following functions:

2. The invention of claim 1 wherein dial-up local Access Numbers are stored in a CSV file.
This CSV file is parsed when the dialer user selects a given state and the results are displayed.
Any given selected Access Number can be placed in the Phone Number field and dialed, thus allowing Internet access across the nation.

3. The invention of claim 1 wherein the Interactive Dialer© utilizes RAS logic to create a connection to the Internet.
Once the function begins dialing, control is passed back to the dialer and a callback function asynchronously assumes the task of processing the connection.
This callback function provides the RAS feedback that is displayed in the RAS Response Region.
A disruption/failure to connect is accompanied by a message box and a beep to inform the dialer user that there was a problem.

4. The invention of claim 1 wherein, once a dial-up connection is established, the Interactive Dialer© takes the dial-up user to an ISP-Client's Companion page© or website (default URL).
This informational page or site allows the ISP-Client to display information immediately before the user has access to the “www.”

5. The invention of claim 1 wherein the Interactive Dialer© has built-in security that allows the authentication server to recognize exclusively the ISP Client-specific Interactive Dialer©, thereby preventing access to the network when using other/generic dialer designs, even if the correct username and password are used.

6. The invention of claim 1 wherein the default URL can be changed “mid-stream”.
Thus, the interactive component sections on the Interactive Dialer© can start dialing and then change the default URL, in effect allowing the Interactive Dialer© to redirect the Dialer.

7. The invention of claim 1 wherein upon connection, the dialer icon in the System Tray will change to indicate that the Interactive Dialer© is connected and two options now appear when the icon is clicked using the right mouse button:
Hangup and Show Status.
Hangup will cause RAS to terminate the connection. Show Status will bring up the RAS Monitor Dialog to display the connection statistics.
Another option to hang up the connection is located on this Dialog.

8. The invention of claim 1 wherein when the New Mail Notification is processed at start-up, it checks for messages.
The effect of this is that the New Mail status is displayed immediately on the face of the Interactive Dialer©.
If the email notification preferences are not set, the Interactive Dialer© displays the email notification preferences dialog to allow the dial-up user to check for new email.
After the message check is complete, a new session is created to rotate the messages in the Administrative Message Notification component.
The New Mail Notification then initiates to process at intervals programmed by the ISP.

9. The inventions of claim 1 wherein the logo, changeable message text, and company URLs are contained in a shared linked-library.
The Interactive Dialer© extracts these resources and then places them in the Banner/Logo section of the Interactive Dialer©.
If this library does not exist, the logo is omitted and a text banner is placed instead.

10. The invention of claim 1 wherein the ISP-Client's text logo and “sub-domain” are in an included .ini file.
If the .ini file does not exist, default values are used instead.
This system allows for the uniqueness of the dialer to provide information for the ISP-Client's users.

11. The invention of claim 1 wherein the default URL informational page or site (sub-domain) allows the ISP-Client to display information immediately before the user has access to the “www.”
The ISP-Client's administrator is able to modify the information on this page using a secure Companion Administration Template©.

12. The invention of claim 1 wherein the Companion Administration Template© is provided to manage the interactive push-message displays on the Interactive Dialer© and the information provided on the Companion page©.
